(19) United States
(12) Patent Application Publication
(10) Pub. No.: US 2022/0319110 A1
(43) Pub. Date: Oct. 6, 2022

(54) GENERATING POINT CLOUD COMPLETION NETWORK AND PROCESSING POINT CLOUD DATA

(71) Applicant: SENSETIME INTERNATIONAL PTE. LTD., Singapore (SG)

(72) Inventors: Junzhe ZHANG, Singapore (SG); Xinyi CHEN, Singapore (SG); Zhongang CAI, Singapore (SG); Haiyu ZHAO, Singapore (SG); Shuai YI, Singapore (SG)

(21) Appl. No.: 17/363,256

(22) Filed: Jun. 30, 2021

Related U.S. Application Data
(63) Continuation of application No. PCT/IB2021/055007, filed on Jun. 8, 2021.

(30) Foreign Application Priority Data
Mar. 30, 2021 (SG) 10202103270P

(51) Int. Cl. G06T 17/00; G06N 3/08; G06N 3/04

(52) U.S. Cl. CPC G06T 17/00; G06N 3/08; G06N 3/0454

(57) ABSTRACT

The embodiments of the present disclosure provide methods and apparatuses for generating point cloud completion network and methods, apparatuses and systems for processing point cloud data. First point cloud data is acquired from a first point cloud completion network based on one or more latent space vectors that are acquired through sampling in latent space, and a second point cloud completion network is generated by adjusting the first point cloud completion network based on a points-distribution feature of the first point cloud data. Since the points-distribution feature of the point cloud data is taken into consideration during generating the second point cloud completion network, the trained second point cloud completion network is capable of correcting the points-distribution feature of the point cloud data, and thus outputting the point cloud data with a relatively even points-distribution feature.

### CROSS REFERENCE TO RELATED APPLICATIONS

The present disclosure is a. continuation application of PCT Application No. PCT/IB2021/055007 filed on Jun. 8, 2021, which claims priority to Singapore Patent Application No. 10202103270P filed on Mar. 30, 2021, the entire contents of which are incorporated herein by reference in their entireties.

### TECHNICAL FIELD

The present disclosure relates to the field of computer vision technology, in particular to methods and apparatuses for generating a point cloud completion network and methods, apparatuses and systems for processing point cloud data.

### BACKGROUND

Point cloud completion is used to repair point cloud data which has lost some (that is, incomplete point cloud data or defect cloud data), and estimate complete point cloud data based on the incomplete point cloud data. The point cloud completion has been widely applied in various fields such as autonomous driving and robot navigation. For a point cloud outputted by a traditional point cloud completion network, its distribution is uneven, which causes a poor effect when it is applied in downstream tasks.

### SUMMARY

The present disclosure provides methods and apparatuses for generating a point cloud completion network, and methods, apparatuses and systems for processing point cloud data.

According to a first aspect of embodiments of the present disclosure, a method of generating a point cloud completion network is provided. The method includes: acquiring one or more latent space vectors through sampling in latent space; and acquiring first point cloud data generated based on the latent space vectors by inputting the one or more latent space vectors into a first point cloud completion network; determining a points-distribution feature of the first point cloud data; and adjusting the first point cloud completion network based on the points-distribution feature to generate a second point cloud completion network.

In some embodiments, determining the points-distribution feature of the first point cloud data includes: determining a plurality of point cloud blocks in the first point cloud data; and calculating a point density variance of the plurality of point cloud blocks as the points-distribution feature of the first point cloud data.

In some embodiments, determining the plurality of point cloud blocks in the first point cloud data includes: sampling, in the first point cloud data, respective points at a plurality of seed positions as seed points; and for each of the seed points, determining a plurality of neighboring points of the seed point, and determining the seed point and the plurality of neighboring points as one point cloud block.

In some embodiments, a point density of a point cloud block is determined based on a distance between the seed point in the point cloud block and each neighboring point of the seed point.

In some embodiments, adjusting the first point cloud completion network based on the points-distribution feature to generate the second point cloud completion network includes: establishing a first loss function based on the points-distribution feature of the first point cloud data, where the first loss function represents a distribution evenness of the points in the first point cloud data; establishing a second loss function based on the first point cloud data and complete point cloud data from a sample point cloud data set, where the second loss function represents a difference between the first point cloud data and the complete point cloud data; and training the first point cloud completion network based on the first loss function and the second loss function to obtain the second point cloud completion network.

In some embodiments, adjusting the first point cloud completion network based on the points-distribution feature to generate the second point cloud completion network includes: establishing a third loss function based on the points-distribution feature of the first point cloud data; establishing a fourth loss function based on a difference between corresponding point cloud data and real point cloud data collected in a physical space, where the corresponding point cloud data is acquired from the first point cloud data by performing a preset degradation process; and optimizing the first point cloud completion network based on the third loss function and the fourth loss function to obtain the second point cloud completion network.

In some embodiments, performing the preset degradation process includes: determining, corresponding to any target point in the real point cloud data, at least one neighboring point in the first point cloud data which is nearest to the target point; and determining a union of respective neighboring points in the first point cloud data corresponding to various target points in the real point cloud data as the corresponding point cloud data.

In some embodiments, the method further includes: acquiring raw point cloud data collected by a point cloud collecting device in a 3D space; performing a point cloud segmentation on the raw point cloud data to obtain second point cloud data of at least one object; and completing the second point cloud data by adopting the second point cloud completion network.

In some embodiments, the method further includes: detecting an association between at least two objects based on the completed second point cloud data of the at least two objects.

According to a second aspect of embodiments of the present disclosure, a method of processing point cloud data is provided. The method includes: acquiring a first to-be-processed point cloud of a game participant and a second to-be-processed point cloud of a game object within a game area; inputting the first to-be-processed point cloud and the second to-be-processed point cloud into a second point cloud completion network to acquire a first processed point cloud and a second processed point cloud, where the second point cloud completion network has been pre-trained, and the first processed point cloud and the second processed point cloud are outputted by the second point cloud completion network and correspond to the first to-be-processed point cloud and the second to-be-processed point cloud respectively; and associating the game participant and the game object based on the first processed point cloud and the second processed point cloud; where the second point cloud completion network is obtained by adjusting a first point cloud completion network based on a points-distribution feature of first point cloud data, and the first point cloud data is generated by the first point cloud completion network based on one or more latent space vectors.

In some embodiments, the game object includes a game coin deposited in the game area; and the method further includes: determining, based on an association result between the first processed point cloud and the second processed point cloud, the game coin which is deposited by the game participant in the game area.

In some embodiments, the method further includes: determining, based on an association result between the first processed point cloud and the second processed point cloud, an action performed on the game object by the game participant.

In some embodiments, acquiring the first to-be-processed point cloud of the game participant and the second to-be-processed point cloud of the game object within the game area includes: acquiring raw point cloud data, which is collected by a point cloud collecting device arranged around the game area; and performing a point cloud segmentation on the raw point cloud data to obtain the first to-be-processed point cloud of the game participant and the second to-be-processed point cloud of the game object.

In some embodiments, the second point cloud completion network is configured to complete the respective first to-be-processed point clouds of game participants of various categories and/or the respective second to-be-processed point clouds of game objects of various categories; or the second point cloud completion network includes a first point cloud completion subnetwork and a second point cloud completion subnetwork, where the first point cloud completion subnetwork is configured to complete the first to-be-processed point cloud of the game participant of a first category, and the second point cloud completion subnetwork is configured to complete the second to-be-processed point cloud of the game object of a second category.

According to a third aspect of embodiments of the present disclosure, an apparatus for generating a point cloud completion network is provided. The apparatus includes: a processor; and a memory for storing executable instructions by the processor. The processor is configured to: acquire one or more latent space vectors through sampling in latent space; acquire first point cloud data generated based on the latent space vectors by inputting the one or more latent space vectors into a first point cloud completion network; determine a points-distribution feature of the first point cloud data; and adjust the first point cloud completion network based on the points-distribution feature to generate a second point cloud completion network.

According to a fourth aspect of embodiments of the present disclosure, an apparatus for processing point cloud data is provided. The apparatus includes: a processor; and a memory for storing executable instructions by the processor. The processor is configured to: acquire a first to-be-processed point cloud of a game participant and a second to-be-processed point cloud of a game object within a game area; input the first to-be-processed point cloud and the second to-be-processed point cloud into a second point cloud completion network to acquire a first processed point cloud and a second processed point cloud, where the second point cloud completion network has been pre-trained, and the first processed point cloud and the second processed point cloud are outputted by the second point cloud completion network and correspond to the first to-be-processed point cloud and the second to-be-processed point cloud respectively; and associate the game participant and the game object based on the first processed point cloud and the second processed point cloud; where the second point cloud completion network is obtained by adjusting a first point cloud completion network based on a points-distribution feature of first point cloud data, and the first point cloud data is generated by the first point cloud completion network based on one or more latent space vectors.

In the embodiments of the present disclosure, first point cloud data is acquired from a first point cloud completion network based on one or more latent space vectors that are acquired through sampling in latent space, and a second point cloud completion network is generated by adjusting the first point cloud completion network based on a points-distribution feature of the first point cloud data. Since the points-distribution feature of point cloud data is taken into consideration during generating the second point cloud completion network, the trained second point cloud completion network is capable of correcting the points-distribution feature of the point cloud data, and thus outputting the point cloud data with a relatively even points-distribution feature.

It should be understood that the above general description and the following detailed description are only exemplary and explanatory and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the technical solutions of the present disclosure.

FIG. 1 is a schematic diagram illustrating incomplete point cloud data according to some embodiments.

FIG. 2 is a schematic diagram illustrating a points-distribution feature of point cloud data according to some embodiments of the present disclosure.

FIG. 3 is a flowchart illustrating a method of generating a point cloud completion network according to some embodiments of the present disclosure.

FIG. 4 is a schematic diagram illustrating a process of training and optimizing a point cloud completion network according to some embodiments of the present disclosure.

FIG. 5 is a schematic diagram illustrating a degradation process performed according to some embodiments of the present disclosure.

FIG. 6 is a schematic diagram illustrating various complete point cloud data candidates outputted by a point cloud completion network.

FIG. 7 is a flowchart illustrating a method of processing point cloud data according to some embodiments of the present disclosure.

FIG. 8 is a block diagram illustrating an apparatus for generating a point cloud completion network according to some embodiments of the present disclosure.

FIG. 9 is a block diagram illustrating an apparatus for processing point cloud data according to some embodiments of the present disclosure.

FIG. 10 is a schematic diagram illustrating a system for processing point cloud data according to some embodiments of the present disclosure.

FIG. 11 is a schematic structural diagram illustrating a computer device according to some embodiments of the present disclosure.

### DETAILED DESCRIPTION OF THE EMBODIMENTS

Embodiments will be described in detail herein, with the examples thereof represented in the drawings. When the following descriptions involve the drawings, like numerals in different drawings refer to like or similar elements unless otherwise indicated. The implementations described in the following embodiments do not represent all implementations consistent with the present disclosure. Rather, they are merely examples of apparatuses and methods consistent with some aspects of the present disclosure as detailed in the appended claims.

The terms used in the present disclosure are only for the purpose of describing specific embodiments, and are not intended to limit the present disclosure. The singular forms “a”, “said” and “the” used in the present disclosure and appended claims are also intended to include plural forms, unless the context clearly indicates other meanings. It should further he understood that the term “and/or” used herein refers to and includes any or all possible combinations of one or more associated listed items. In addition, the term “at least one” herein means any one of a plurality of types or any combination of at least two of the plurality of types.

It should be understood that although the terms first, second, third, etc. may be used in the present disclosure to describe various information, the information should not be limited to these terms. These terms are only used to distinguish the same type of information from each other. For example, without departing from the scope of the present disclosure, first information may be referred as second information; and similarly, second information may also be referred as first information. Depending on the context, the word “if” as used herein can he interpreted as “upon” or “when” or “in response to determination”.

In order to make those skilled in the art better understand the technical solutions in the embodiments of the present disclosure, and make the described objects, features and advantages of the embodiments of the present disclosure more apparent, the technical solutions in the embodiments of the present disclosure will be further described in detail below with reference to the accompanying drawings.

In practical applications, point cloud data is always expected to be collected and performed with some processing. For example, in the field of autonomous driving, a LiDAR, may be installed on an autonomous vehicle, and the LiDAR may be used to collect point cloud data around the vehicle and analyze the point cloud data to determine respective moving speeds of obstacles around the vehicle, so as to perform a route planning for the vehicle effectively. For another example, in the field of robot navigation, point cloud data of the surrounding environment of the robot may be collected, and the robot may be positioned based on various objects identified from the point cloud data. For another example, in some game scenarios, point cloud data in a game area may be collected, and various targets (for example, game participants and game objects) identified from the point cloud data may be associated.

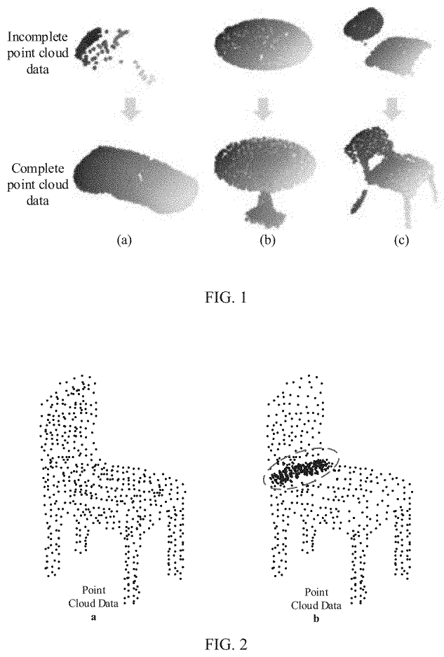

However, in actual scenarios, due to occlusion and other reasons, the collected 3D point cloud is always not complete point cloud data, but incomplete point cloud data. For example, for a 3D object, the surface facing away from a point cloud collecting device may be occluded by the surface facing the point cloud collecting device, resulting in the point cloud facing away from the point cloud collecting device cannot be collected. Even if it is a flat object, because there are often multiple overlapping objects in the scenarios, the surface of one object may be occluded by the surface of another object, resulting in that the incomplete point cloud data is collected. In addition, there are many other reasons for the generation of the incomplete point cloud, and the collected firms of the incomplete point cloud are also diverse. FIG. 1 is a schematic diagram illustrating incomplete point clouds collected in a physical space and corresponding complete point clouds according to some embodiments.

It should be noted that the incomplete point cloud data in the present disclosure refers to point cloud data that cannot represent the complete shape of the object. For example, when an object includes one or more surfaces, a part of the surfaces or a partial area of one surface may be occluded, and the collected point cloud data does not include the points of the occluded surface or area, so that the collected point cloud data cannot represent the corresponding shape of the occluded surface or area. The surfaces face different directions, or there is a sudden change in direction between each other. Correspondingly, the complete point cloud data refers to point cloud data that can represent the complete shape of the object. For example, in a case where an object includes one or more surfaces, the point cloud data includes points on each surface, so that the point cloud data can completely represent the shape of each surface.

Operations based on the incomplete point cloud are difficult to achieve expected results. Therefore, it is necessary to complete the incomplete point cloud data to obtain the complete point cloud data corresponding to the incomplete point cloud data. In related arts, a point cloud completion network is generally adopted to complete the incomplete point cloud data. However, the point cloud outputted by a traditional point cloud completion network is unevenly distributed. FIG. 2 illustrates a comparison diagram of evenly distributed point cloud data a and unevenly distributed point cloud data b. It can be seen that in point cloud data b, most of the collected points are distributed in the dotted box, while the distribution of other points in other regions is more scattered. Since the number of points that the point cloud completion network can handle is relatively fixed, the unevenness of the point cloud data means that the number of points in some areas may not be enough for the point cloud completion network to obtain enough information for point cloud completion, which causes an inaccurate result of point cloud completion. Further, the unevenness of the point cloud data may cause a poor effect when the outputted point cloud data is applied in downstream tasks. For example, when identifying a target object in unevenly distributed point cloud data, the number of the points representing some areas of the target object may be too small to accurately identify the target object, which leads to recognition errors.

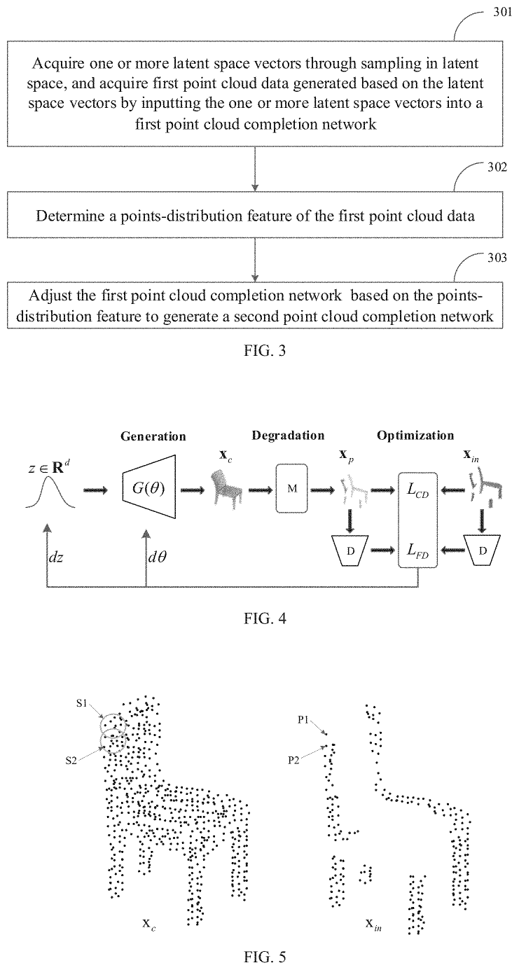

With that in mind, the present disclosure provides a method of generating a point cloud completion network. As illustrated in FIG. 3, the method includes the following steps.

At step 301, one or more latent space vectors are acquired through sampling in latent space, and first point cloud data generated based on the latent space vectors is acquired by inputting the one or more latent space vectors into a first point cloud completion network.

At step 302, a points-distribution feature of the first point cloud data is determined.

At step 303, the first point cloud completion network is adjusted based on the points-distribution feature to generate a second point cloud completion network.

In some embodiments of the present disclosure, the method procedure of generating the second point cloud completion network by adjusting the first point cloud completion network may be applied in a process of training a point cloud completion network. Alternatively, in some embodiment of the present disclosure, the method procedure of generating the second point cloud completion network by adjusting the first point cloud completion network may be applied in a process of optimizing a trained point cloud completion network.

In the step 301, the first point cloud completion network may be obtained, for example, based on any kind of Generative Adversarial Network (GAN) including but not limited to tree-GAN or r-GAN.

The latent space vectors may be acquired through sampling in the latent space, and the sampling way may be a random sampling. In some embodiments, the latent space may be a 96-dimensional space, and one or more 96-dimensional vectors may be randomly generated for each sampling, that is, one or more raw latent space vectors,

In the step 302, for a plurality of point cloud blocks in the first point cloud data, their point density variance may be determined as the points-distribution feature of the first point cloud data. A larger variance indicates a more uneven distribution of the points among various point cloud blocks in the first point cloud data; on the contrary, a less variance indicates a more even distribution of the points among various point cloud blocks.

In some embodiments, respective points at a plurality of seed positions may be sampled in the first point cloud data as seed points. For each of the seed points, a plurality of neighboring points of the seed point may be determined, and the seed point and the plurality of neighboring points may be determined as one point cloud block. In some embodiments, the number of the points in each point cloud block may be fixed. Therefore, the point density of a point cloud block may be directly determined based on a distance between the seed point in the point cloud block and each neighboring point of the seed point. In this way, the complexity of calculating the point density is reduced.

N seed positions may be randomly sampled in the first point cloud data. For example, the sampling way may be a farthest point sampling (FPS), so that the distance between various seed positions is the farthest. The points-distribution feature of one point cloud block may be determined based on an average distance between each point in the point cloud block and a certain position in the point cloud block, for example, a seed position. The network parameters of the first point cloud completion network may be optimized to minimize the variance of the average distances corresponding to respective point cloud blocks in the first point cloud data.

In the step 303, the first point cloud completion network may be adjusted based on the points-distribution feature to generate the second point cloud completion network.

In some embodiments of the present disclosure, adjusting the first point cloud completion network to generate the second point cloud completion network may be applied in a process of training a point cloud completion network, that is, the above first point cloud completion network is a raw point cloud completion network without undergoing any training, and the second point cloud completion network is a trained point cloud completion network. Alternatively, in some embodiment of the present disclosure, adjusting the first point cloud completion network to generate the second point cloud completion network may be applied in a process of optimizing a trained point cloud completion network, that is, the above first point cloud completion network is a trained point cloud completion network, and the second point cloud completion network is an optimized point cloud completion network. The process of training and optimizing the point cloud completion network are separately explained below.

In the training process, complete point cloud data from a sample point cloud data set may be determined as target point cloud data. Taking a generative adversarial network as an example, the first point cloud completion network may be taken as a generator, and adversarial training is performed with a preset discriminator to generate the second point cloud completion network. The input of the generator is the latent space vectors sampled in the latent space, and the input of the discriminator is the complete point cloud data from the sample point cloud data set. Since it is difficult to collect complete point cloud data in real scenarios, the complete point cloud data adopted in the embodiments of the present disclosure may be artificially generated, for example, the complete point cloud data from a ShapeNet data set. In addition, since it is also difficult to construct paired incomplete-complete point cloud sample data, in some embodiments of the present disclosure, the latent space vectors, instead of the incomplete point cloud, are inputted into the generator to generate the complete point cloud, which reduces the difficulty of acquiring sample data. And, training the first point cloud completion network in a generating-discriminating way can achieve better accuracy.

The first point cloud data, outputted by the first point cloud completion network based on the latent space vectors, may be acquired. A first loss function is established based on the points-distribution feature of the first point cloud data, and represents a distribution evenness of the points in the first point cloud data. A second loss function is established based on the first point cloud data and the complete point cloud data from the sample point cloud data set, and represents a difference between the first point cloud data and the complete point cloud data. The second point cloud completion network is obtained by training the first point cloud completion network based on the first loss function and the second loss function. Here, the first loss function may be written as:

$${f}_{patch} = Var ( {\{ {ρ}_{j} \}}_{j = 1}^{n} ) , {ρ}_{j} = \frac{1}{k} {\sum }_{i = 1}^{k} {dist}_{ij}^{2}$$

In this formula, L_{patch} indicates the first loss function, Var represents the variance, ρⱼ indicates the average distance between each point and the seed position in the j^{th} point cloud block, n indicates a total number of the point cloud blocks, k indicates a total number of the points in a point cloud block, distᵢⱼ indicates the distance between the i^{th} point in the j^{th} point cloud block and the seed position. The network parameters of the first point cloud completion network may be adjusted to minimize the variance of the average distance corresponding to each point cloud block in the point cloud data outputted by the second point cloud completion network. In this way, in various point cloud block, the average distances between each point and the seed position may be similar, thereby improving the distribution evenness of the points in the cloud data outputted by the second point cloud completion network.

The role of the second loss function is to make the point cloud data outputted by the second point cloud completion network as similar as possible to the point cloud data from the sample point cloud data set, to a degree that it is difficult to be distinguished by the discriminator. The second loss function may be determined based on a result of discriminating, by the discriminator, the first point cloud data with the point cloud data from the sample point cloud data set.

In the optimizing process, real point cloud data collected in the physical space may be taken as the target point cloud data. The best one may be selected from a plurality of raw latent space vectors as the latent space vector, referred to as the target latent space vector. For each raw latent space vector, the point cloud data, which is generated by the first point cloud completion network based on the raw latent space vector, may be acquired, and a target function of the raw latent space vector may be determined based on the real point cloud data and the point cloud data corresponding to the raw latent space vector. Then, based on the target functions of various raw latent space vectors, the target latent space vector is determined from the various raw latent space vectors. The target function, L, of the respective raw latent space vector may be calculated in accordance with the following formula:

$${L}_{CD} ( {x}_{p} , {x}_{in} ) = \frac{1}{\vert {x}_{p} \vert} {\sum }_{p ∈ {x}_{p}} {min}_{q ∈ {x}_{in}} {‖ p - q ‖}_{2}^{2} + \frac{1}{\vert {x}_{in} \vert} {\sum }_{q ∈ x} {min}_{p ∈ {x}_{p}} {‖ p - q ‖}_{2}^{2}$$

$${L}_{FD} = ‖ D ( {x}_{p} ) - D ( {x}_{in} ) ‖ {1}_{}$$

In this formula, L_{CD} and L_{FD} represent a chamfer distance and a feature distance respectively, and xₚ represents the corresponding point cloud data that is acquired from the first point cloud data by performing the preset degradation process, xᵢₙ represents the real point cloud data, p and q represent the point in the first point cloud data and the point in the real point cloud data respectively, ∥·∥₁ and ∥·∥₂ represent norm 1 and norm 2 respectively, D(xₚ) and D(xᵢₙ) represent a feature vector of xₚ and a feature vector of xᵢₙ respectively. The above is only an example of the target function. In addition to the target function described above, other types of target function may also be adopted according to actual requirements, which will not be repeated here.

After acquiring the target functions corresponding to the respective raw latent space vectors, the raw latent space vector with the smallest target function may be determined as the target latent space vector. In the above way, in the embodiments of the present disclosure, the optimal target latent space vector may be selected from the plurality of raw latent space vectors for the process of training and optimizing the point cloud completion network, which can accelerate a speed of training and optimizing the point cloud completion network and improve an efficiency of optimizing the point cloud completion network.

After the optimization processing, the difference between the corresponding point cloud data, which is acquired from the first point cloud data by performing the preset degradation process and is outputted by the first point cloud completion network, and the real point cloud data collected in the physical space is within a preset difference range. In practice, the above-mentioned “the difference between the corresponding point cloud data, which is acquired from the first point cloud data by performing the preset degradation process, and the real point cloud data collected in the physical space is within the preset difference range” may be taken as an optimization target, and the parameters of the first point cloud completion network may be adjusted by setting the corresponding optimization target, so as to achieve optimizing the first point cloud completion network and obtain the second point cloud completion network.

Specifically, a third loss function may be established based on the points-distribution feature of the first point cloud data; a fourth loss function may be established based on a difference between the corresponding point cloud data, which is acquired from the first point cloud data by performing the preset degradation process, and real point cloud data; and the first point cloud completion network may be optimized based on the third loss function and the fourth loss function to obtain the second point cloud completion network. The above function L_{patch} may be taken as the third loss function, and the target function corresponding to the target latent space vector may be taken as the fourth loss function.

The above process of training and optimizing the first point cloud completion network is illustrated in FIG. 4. In particular, a point cloud completion network N₁ is taken as the generator in a generative adversarial network. The generative adversarial network includes a generator G and a discriminator D. The two D illustrated in FIG. 4 may be the same discriminator, x_{C} is x_{C1} or x_{C2}, z is z₁ or z₂, xᵢₙ is xᵢₙ₁ or xᵢₙ₂. During the training process, an adversarial training between the generator G and the discriminator D is adopted. The latent space vector z₁ randomly sampled is taken as the input of the generator G. the complete point cloud data xᵢₙ₁ from the sample point cloud data set is taken as the input of the discriminator D, and the purpose of the training is to make it difficult for the discriminator D to distinguish the complete point cloud data x_{C1} generated by the generator G from the complete point cloud data xᵢₙ₁ from the sample point cloud data set, and make the trained point cloud completion network N₂ output more even complete point cloud data. Therefore, at the training stage, the latent space vector z₁ and the parameters θ₁ of the generator in the point cloud completion network N₁ are optimized by adopting a gradient descent algorithm, so as to minimum both the first loss function and the second loss function and thereby obtain the point cloud completion network N₂. The first loss function is acquired based on the points-distribution feature of the complete point cloud data x_{C1} that is generated by the point cloud completion network N₁ based on the latent space vector z₁, and the second loss function is acquired based on the distinguished result from the discriminator. Through the training, the point cloud completion network N₁ can learn better prior information of spatial geometry based on the complete point cloud data from the sample point cloud data set. Based on the features outputted by an intermediate layer of the discriminator D in the trained generative adversarial network, the distance between the features may be calculated.

At the optimizing stage, the target latent space vector z₂ may be acquired from a plurality of raw latent space vectors randomly sampled. Through inputting the target latent space vector z₂ into the point cloud completion network N₂, the complete point cloud data x_{C2} outputted by the point cloud completion network N₂ is obtained. The third loss function is determined based on the points-distribution feature of the complete point cloud data x_{C2}, and the fourth loss function is determined based on the distance between the point cloud data xₚ and the real point cloud data xᵢₙ₂, where xₚ is acquired from the complete point cloud data x_{C2} after the degradation. The latent space vector z₂ and the parameters θ₂ of the generator G in the point cloud completion network N₂ are optimized by adopting the gradient descent algorithm, so as to minimum both the third loss function and the fourth loss function and thereby obtain the point cloud completion network N₃ as the final point cloud completion network responsible for completing the point cloud.

According to the embodiments of the present disclosure, it is not necessary to adopt the point cloud pair composed of the complete point cloud data and the incomplete point cloud data. Since the entire training process does not involve any specific form of incomplete point cloud, it is suitable to complete various forms of incomplete point clouds, has higher generalization performance, and has better robustness for the point clouds with different incomplete degrees. Moreover, for the point cloud data generated by the optimized point cloud completion network, after the preset degradation process is performed, its difference with the real point cloud data is rather small, so that the point cloud completed result is more accurate.

In addition, according to the embodiments of the present disclosure, the first point cloud data is acquired from the first point cloud completion network based on the latent space vectors that are acquired through sampling in the latent space, and the second point cloud completion network is generated by adjusting the first point cloud completion network based on the points-distribution feature of the first point cloud data. Since the points-distribution feature of the point cloud data is taken into consideration during generating the second point cloud completion network, the trained second point cloud completion network is capable of correcting the points-distribution feature of the point cloud data, and thus outputting the point cloud data with a relatively even points-distribution feature.

In some embodiments, the degradation process may be performed on the first point cloud data in the following way: for any target point in the real point cloud data, at least one neighboring point that is nearest to the target point is determined in the first point cloud data; and corresponding to various target points in the real point cloud data, for the union of the respective neighboring points in the first point cloud data is determined as the corresponding point cloud data.

As illustrated in FIG. 5, P1 is a point in the real point cloud data xᵢₙ, and the neighboring points in the first point cloud data x_{C} corresponding to P1 may be acquired. The neighboring points may include k points in x_{C} that are nearest to P1, that is, the points shown in area S1. Similarly, the neighboring points in the first point cloud data x_{C} corresponding to point P2 in the real point cloud data xᵢₙ may be acquired, that is, the points shown in area S2. Similarly, the neighboring points in the first point cloud data x_{C} corresponding to other target points in the real point cloud data xᵢₙ may be acquired. Said other target points may include part points in the real point cloud data xᵢₙ, for example, the points evenly sampled in the real point cloud data xᵢₙ in accordance with a set sampling rate. In some embodiments, the set sampling rate<1/k, so that in the corresponding point cloud data acquired by performing the degradation process, the number of the points is reduced. Since the neighboring points of various target point may partially overlap, the point cloud formed by the union of the neighboring points of various target points may be determined as the corresponding point cloud data that is acquired from the first point cloud data by performing the degradation process.

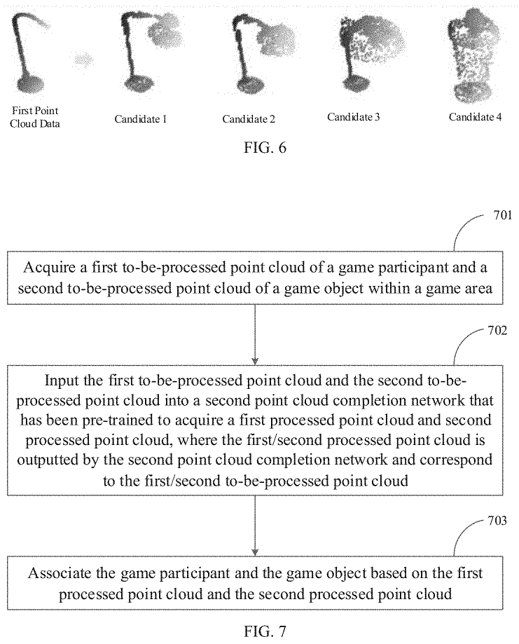

After the second point cloud completion network is obtained, the second point cloud data may be completed through the second point cloud completion network. For each piece of inputted second point cloud data, the second point cloud completion network may output one or more complete point cloud data candidates. FIG. 6 is a schematic diagram of the first point cloud data and corresponding complete point cloud data candidates according to some embodiments. Based on the second point cloud data, the second point cloud completion network has outputted a total of 4 complete point cloud data candidates for selection. Further, a selection instruction for each complete point cloud data candidate may be acquired, and in response to the selection instruction, one of the complete point cloud data candidates is selected as the complete point cloud data corresponding to the second point cloud data.

The present disclosure may be used in any scene equipped with a 3D sensor (such as a depth camera or a LiDAR), and the incomplete point cloud data of the entire scene may be scanned by the 3D sensor. Corresponding to the incomplete point cloud data of each object in the scene, complete point cloud data is generated through the second point cloud completion network, and then a 3D reconstruction of the entire scene may be performed. The reconstructed scene may provide accurate spatial information, such as detecting the distance between a human body and another object in the scene, and the distance between people. The spatial information may be used to associate people with objects, and associate people with people, so as to improve the accuracy of the association.

In some embodiments, multiple frames of second point cloud data may be acquired, and associated. The multiple frames of second point cloud data may be second point cloud data of objects of a same category. For example, in a game scene, each frame of second point cloud data may be the point cloud data of a game participant. By associating the point cloud data of multiple game participants, each game participant participating in a same game in a same game area can be determined. The multiple frames of second point cloud data may also be the second point cloud data of objects of different categories. Still taking a game scene as an example, the multiple frames of second point cloud data may include the point cloud data of game participants and the point cloud data of the game objects. By associating the point cloud data of a game participant with the point cloud data of a game object, the relationship between the game participant and the game object can be determined, for example, game coin, game chesses and cards, and cash belonging to the game participant; the game area where the game participant is located; and the seat where the game participant sits, etc.

The position and state of the game participant or the game object in the game scene may change in real time. The relationship between two game participants, the relationship between a game participant and a game object may also change in real time, and the real-time changing information is of great significance for the analysis of the game state and the monitoring of the game progress. The incomplete point cloud data of the game participants and/or the game objects collected by the point cloud collecting device is completed, which is beneficial to improve the accuracy of the association result between the point cloud data and further improve the reliability of the results of game state analysis and game progress monitoring based on the association result.

In some embodiments, after the second point cloud data is acquired, an object included in the second point cloud data may be identified, so as to determine the category of the object. The associating process may also be performed on the multiple frames of second point cloud data based on the identification result. Further, in order to improve the accuracy of the association processing and/or object identification, the second point cloud data may be homogenized before the association processing and/or object identification are performed.

In some embodiments, the raw point cloud data collected by the point cloud collecting device often include the point cloud data of a plurality of objects. In order to be easily processed, it may acquire the raw point cloud data collected by the point cloud collecting device in the 3D space, perform a point cloud segmentation on the raw point cloud data to obtain second point cloud data of at least one object, and complete the second point cloud data by adopting the second point cloud completion network.

As illustrated in FIG. 7, some embodiments of the present disclosure also provide a method of processing point cloud data, and the method includes the following steps.

At step 701, a first to-be-processed point cloud of a game participant and a second to-be-processed point cloud of a game object are acquired, where the game participant and the game object are within a game area.

At step 702, the first to-be-processed point cloud and the second to-be-processed point cloud are inputted into a second point cloud completion network to acquire a first processed point cloud and a second processed point cloud, where the second point cloud completion network has been pre-trained, and where the first processed point cloud and the second processed point cloud are outputted by the second point cloud completion network and correspond to the first to-be-processed point cloud and the second to-be-processed point cloud respectively.

At step 703, the game participant and the game object are associated based on the first processed point cloud and the second processed point cloud.

The second point cloud completion network is obtained by adjusting a first point cloud completion network based on a points-distribution feature of first point cloud data, and the first point cloud data is generated by the first point cloud completion network based on one or more latent space vectors.

The game participant may include, but is not limited to, at least one of a game referee, a game player, and a game audience.

In some embodiments, the game object includes a game coin deposited in the game area; and the method further includes the following step: the game coin, which is deposited by the game participant in the game area, is determined based on an association result between the first processed point cloud and the second processed point cloud. Each game participant may have a certain number of game coins for playing the game. By associating the game participant with the game coins, it may determine the number of the coins that the game participant has deposited into the game, the number of the coins that the game participant owns and has deposited into different stages of the game, and whether the operations in the game process comply with pre-set rules of the game, or it may make compensation based on both the amount of deposited chips and the result of the game when the game is over.

In some embodiments, the method further includes: determining an action performed by the game participant on the game object based on the association result of the first processed point cloud data and the second processed point cloud data. The action may include sitting, depositing coins, dealing cards, and the like.

In some embodiments, acquiring the first to-be-processed point cloud data of the game participant and the second to-be-processed point cloud data of the game object within the game area includes: acquiring raw point cloud data collected by the point cloud collecting device arranged around the game area; performing a point cloud segmentation on the raw point cloud data to obtain the first to-be-processed point cloud data of the game participant and the second to-be-processed point cloud data of the game object.

In some embodiments, the second point cloud completion network is configured to complete the first to-be-processed point cloud data of the game participants of multiple categories and/or the second to-be-processed point cloud data of the game objects of multiple categories. In this case, multiple categories of complete point cloud data may be adopted to train the second point cloud completion network, and multiple categories of real point cloud data may be adopted to optimize the network at a network optimization stage.

Alternatively, the second point cloud completion network includes a first point cloud completion subnetwork and a second point cloud completion subnetwork. The first point cloud completion subnetwork is configured to complete the first to-be-processed point cloud data of the game participant of a first category, and the second point cloud completion subnetwork is configured to complete the second to-be-processed point cloud data of the game object of a second category. In this case, different categories of complete point cloud data may be used to train different point cloud completion subnetworks respectively, and each trained point cloud completion subnetwork is further optimized based on the real point cloud data of the corresponding category.

The second point cloud completion network adopted in the embodiments of the present disclosure may be generated based on the foregoing method of generating a point cloud completion network. For details, please refer to the foregoing embodiments of the method of generating the point cloud completion network, which will not be repeated here.

A person skilled in the art may understand that, in the described methods of the specific implementation, the drafting order of each step does not imply that the strictly executed order forms any limitation to the implementation process, and the specific execution order of each step should be determined by its function and possibly intrinsic logic.

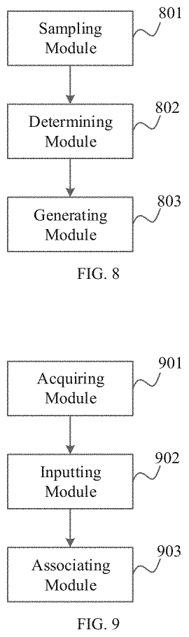

As illustrated in FIG. 8, the present disclosure also provides an apparatus for generating a point cloud completion network. The apparatus includes:

a sampling module 801, configured to acquire one or more latent space vectors through sampling in latent space, and acquire first point cloud data generated based on the latent space vectors by inputting the one or more latent space vectors into a first point cloud completion network;

a determining module 802, configured to determine a points-distribution feature of the first point cloud data; and

a generating module 803, configured to adjust the first point cloud completion network based on the points-distribution feature to generate a second point cloud completion network.

In some embodiments,the determining module includes: a point cloud block determining unit, configured to determine a plurality of point cloud blocks in the first point cloud data; and a calculating unit, configured to calculate a point density variance of the plurality of point cloud blocks as the points-distribution feature of the first point cloud data.

In some embodiments, the point cloud block determining unit includes: a sampling subunit, configured to sample, in the first point cloud data, respective points at a plurality of seed positions as seed points; and a determining subunit, configured to for each of the seed points, determine a plurality of neighboring points of the seed point, and determine the seed point and the plurality of neighboring points as one point cloud block.

In some embodiments, a point density of a point cloud block is determined based on a distance between the seed point in the point cloud block and each neighboring point of the seed point.

In some embodiments, the generating module includes: a first establishing unit, configured to establish a first loss function based on the points-distribution feature of the first point cloud data, where the first loss function represents a distribution evenness of the points in the first point cloud data; a second establishing unit, configured to establish a second loss function based on the first point cloud data and complete point cloud data from a sample point cloud data set, where the second loss function represents a difference between the first point cloud data and the complete point cloud data; and a training unit, configured to train the first point cloud completion network based on the first loss function and the second loss function to obtain the second point cloud completion network.

In some embodiments, the generating module includes: a third establishing unit, configured to establish a third loss function based on the points-distribution feature of the first point cloud data; a fourth establishing unit, configured to establish a fourth loss function based on a difference between corresponding point cloud data and real point cloud data collected in a physical space, where the corresponding point cloud data is acquired from the first point cloud data by performing a preset degradation process; and an optimizing unit, configured to optimize the first point cloud completion network based on the third loss function and the fourth loss function to obtain the second point cloud completion network.

In some embodiments, the apparatus further includes: a neighboring point determining module, configured to determine, corresponding to any target point in the real point cloud data, at least one neighboring point in the first point cloud data which is nearest to the target point; and a degradation processing module, configured to determine a union of respective neighboring points in the first point cloud data corresponding to various target points in the real point cloud data as the corresponding point cloud data.

In some embodiments, the apparatus further includes: a raw point cloud data acquiring module, configured to acquire raw point cloud data collected by a point cloud collecting device in a 3D space; a point cloud segmenting module, configured to perform a point cloud segmentation on the raw point cloud data to obtain second point cloud data of at least one object; and a completing module, configured to complete the second point cloud data by adopting the second point cloud completion network.

In some embodiments, the apparatus further includes: a detecting module, configured to detect an association between at least two objects based on the completed second point cloud data of the at least two objects.

As illustrated in FIG. 9, the present disclosure also provides an apparatus for processing point cloud data. The apparatus includes:

an acquisition module 901, configured to acquire a first to-be-processed point cloud of a game participant and a second to-be-processed point cloud of a game object, where the game participant and the game object are within a game area;

an inputting module 902, configured to input the first to-be-processed point cloud and the second to-be-processed point cloud into a second point cloud completion network to acquire a first processed point cloud and a second processed point cloud, where the second point cloud completion network has been pre-trained, and where the first processed point cloud and the second processed point cloud are outputted by the second point cloud completion network and correspond to the first to-be-processed point cloud and the second to-be-processed point cloud respectively; and

an associating module 903, configured to associate the game participant and the game object based on the first processed point cloud and the second processed point cloud.

The second point cloud completion network is obtained by adjusting a first point cloud completion network based on a points-distribution feature of first point cloud data, and the first point cloud data is generated by the first point cloud completion network based on one or more latent space vectors.

In some embodiments, the game object includes a game coin deposited in the game area; and the apparatus further includes: a game coin determining module, configured to determine, based on an association result between the first processed point cloud and the second processed point cloud, the game coin which is deposited by the game participant in the game area.

In some embodiments, the apparatus further includes: an action determining module, configured to determine, based on an association result between the first processed point cloud and the second processed point cloud, an action performed on the game object by the game participant.

In some embodiments, the acquiring module includes: a raw point cloud data acquiring unit, configured to acquire raw point cloud data, which is collected by a point cloud collecting device arranged around the game area; and a point cloud segmenting unit, configured to perform a point cloud segmentation on the raw point cloud data to obtain the first to-be-processed point cloud of the game participant and the second to-be-processed point cloud of the game object.

In some embodiments, the second point cloud completion network is configured to complete the respective first to-be-processed point clouds of game participants of multiple categories and/or the respective second to-be-processed point clouds of game objects of multiple categories, or the second point cloud completion network includes a first point cloud completion subnetwork and a second point cloud completion subnetwork, where the first point cloud completion subnetwork is configured to complete the first to-be-processed point cloud of the game participant of a first category, and the second point cloud completion subnetwork is configured to complete the second to-be-processed point cloud of the game object of a second category.

In some embodiments, the functions or modules contained in the apparatuses provided in the embodiments of the present disclosure may be used to execute the methods described in the above method embodiments. Their specific implementation may refer to the description of the above method embodiments, and will not be repeated here for brevity.

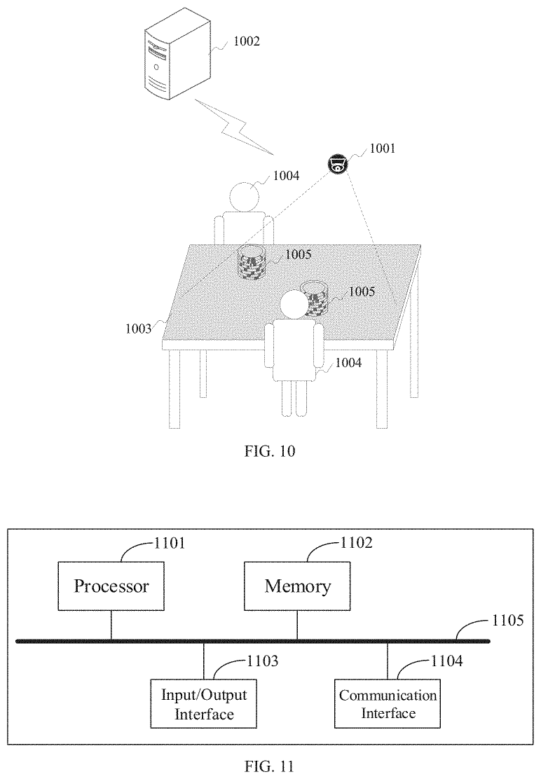

As illustrated in FIG. 10, the embodiments of the present disclosure also provide a system for processing point cloud data. The system includes a point cloud collecting device 1001 and a processing unit 1002. The point cloud collecting device 1001 is arranged around a game area 1003 and is configured to collect a first to-be-processed point cloud of a game participant 1004 and a second to-be-processed point cloud of a game object 1005, where the game participant 1004 and the game object 1005 are within the game area 1003. The processing unit 1002 is connected to and communicated with the point cloud collecting device 1001, and is configured to input the first to-be-processed point cloud and the second to-be-processed point cloud into a second point cloud completion network to acquire a first processed point cloud and a second processed point cloud, and associate the game participant and the game object based on the first processed point cloud and the second processed point cloud, where the second point cloud completion network has been pre-trained, and where the first processed point cloud and the second processed point cloud are outputted by the second point cloud completion network and correspond to the first to-be-processed point cloud and the second to-be-processed point cloud respectively.

The second point cloud completion network is obtained by adjusting a first point cloud completion network based on a points-distribution feature of first point cloud data, and the first point cloud data is generated by the first point cloud completion network based on one or more latent space vectors.

In some embodiments, the point cloud collecting device 1001 may be a LiDAR or a depth camera. One or more point cloud collecting devices 1001 may be arranged around the game area. Different point cloud collecting devices 1001 may collect point cloud data of different sub-areas within the game area, and the sub-areas collected by different point cloud collecting devices 1001 may be overlapped.

There may be one or more game participants within the game area. Each game participants may correspond to one or more game objects, including but not limited to game coin, cash, seat, chess and card, Logo prop, game table, and the like. By identifying the target object based on the processed point cloud data, the categories of the objects included in different point cloud data may be determined, and the spatial information where the objects of each category are located may also be determined. By associating the first processed point cloud data and the second processed point cloud data, the relationship between various game objects and game participants may be acquired, and an action performed by a game participant may also be determined, and thus whether the action performed by the game participant comply with pre-set rules of the game may be determined.

The embodiments of this specification also provide a computer device, which includes at least a memory, a processor, and a computer program stored in the memory and executable on the processor, where the computer program is executed by the processor to implement the method according to any one of the above embodiments.

FIG. 11 illustrates a more specific hardware structure diagram of a computing device provided by some embodiments of the present description, and the device may include a processor 1101, a memory 1102, an input/output interface 1103, a communication interface 1104, and a bus 1105. The processor 1101, the memory 1102, the input/output interface 1103, and the communication interface 1104 implement a communication connection between each other inside the device through the bus 1105.

The processor 1101 may be implemented by adopting a common central processing unit (CPU), a microprocessor, an application specific integrated circuit (ASIC), or one or more integrated circuits, etc., for executing relevant programs to implement the technical solutions provided by the embodiments of the present description. The processor 1101 may also include a graphics card, such as an Nvidia titan X graphics card or a 1080Ti graphics card.

The memory 1102 may be implemented in the form of a read only memory (ROM), a random access memory (RAM), a static storage device, a dynamic storage device, and the like. The memory 1102 may store an operating system and other application programs. When the technical solutions provided by the embodiments of the present specification are implemented through software or firmware, related program codes are stored in the memory 1102 and are invoked and executed by the processor 1101.

The input/output interface 1103 is configured to connect an input/output module to realize information input and output. The input/output module may be configured in the device as a component (not illustrated in the drawings), or it may be attached to the device to provide corresponding functions. The input device may include a keyboard, a mouse, a touch screen, a microphone, various sensors, etc., and an output device may include a display, a speaker, a vibrator, an indicator light, and the like.

The communication interface 1104 is configured to connect a communication module (not illustrated in the drawings) to implement communication and interaction between the device and other devices. The communication module may realize the communication through wired means such as USB and a network cable, or through wireless means such as mobile network, WIFI, and Bluetooth.

The bus 1105 includes a path to transmit information between various components of the device, for example, the processor 1101, the memory 1102, the input/output interface 1103, and the communication interface 1104.

It should be noted that although the above device only illustrates the processor 1101, the memory 1102, the input/output interface 1103, the communication interface 1104, and the bus 1105, the device, in the specific implementation process, may also include other necessary components for normal operation. In addition, those skilled in the art can understand that the above-mentioned device may merely include the components necessary to implement the solutions of the embodiments of the present specification, and not necessarily include all the components illustrated in the drawings.

Embodiments of the present disclosure further provides a computer readable storage medium having a computer program stored thereon, where the program is executed by a processor to perform the method according to any one of the embodiments as described above.

The computer readable medium includes permanent and non-permanent, removable and non-removable medium, and information storage may be realized by any method or technology. The information may be computer readable instructions, data structures, program modules, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, CD-ROM, digital versatile disc (DVD) or other optical storage, magnetic cassettes, magnetic tape storage or other magnetic storage devices or any other non-transmission media, and may be configured to store information that can be accessed by computing devices. According to the definition in this article, the computer readable medium does not include transitory media, such as modulated data signals and carrier waves.

From the description of the above implementations, it can be known that those skilled in the art can clearly understand that the embodiments of this specification can be implemented by means of software plus a necessary general hardware platform. Based on such understanding, for the technical solutions of the embodiments of the present description, their essential part, the part contributing to the prior art in other words, may be embodied in the form of a software product. The computer software product may be stored in a storage medium. For example, a ROM/RAM, a magnetic disk, an optical disk, and the like. The computer software product may include several instructions for enabling a computer device (which may be a personal computer, a server, or a network device, etc.) to execute the method described in each embodiment or some part of the embodiment of the present description.

The systems, apparatuses, modules, or units explained in the above embodiments may be implemented by computer chips or entities, or implemented by products with certain functions. A typical implementation apparatus is a computer, and a specific form of the computer may be a personal computer, a laptop computer, a cellular phone, a camera phone, a smart phone, a personal digital assistant, a media player, a navigation device, an e-mail transceiver device, a game console, a tablet computer, a wearable device, or a combination of any of these devices.

Various embodiments in the present description are described in a progressive manner, and parts similar to each other may be referred to for each other. The description of each embodiment is different from the other embodiments. Especially, for the apparatus embodiments, since they are basically similar to the method embodiments, the description is simplified, and reference may be made to corresponding parts of the description of the method embodiments. The apparatus embodiments described above are merely schematic, in which the modules described as separate components may or may not be physically separated, and the functions of the modules may be implemented in one or more software and/or hardware when the embodiments of the present description are implemented. Part or all of the modules may be selected according to actual requirements to implement the objectives of the solutions in the embodiments. Those of ordinary skill in the art can understand and implement the present disclosure without creative work.

1. A method of generating a point cloud completion network, comprising:
acquiring one or more latent space vectors through sampling in latent space;
acquiring first point cloud data generated based on the latent space vectors by inputting the one or more latent space vectors into a first point cloud completion network;
determining a points-distribution feature of the first point cloud data; and
adjusting the first point cloud completion network based on the points-distribution feature to generate a second point cloud completion network.

2. The method according to claim 1. wherein determining the points-distribution feature of the first point cloud data comprises:
determining a plurality of point cloud blocks in the first point cloud data; and
calculating a point density variance of the plurality of point cloud blocks as the points-distribution feature of the first point cloud data.

3. The method according to claim 2, wherein determining the plurality of point cloud blocks in the first point cloud data comprises:
sampling, in the first point cloud data, respective points at a plurality of seed positions as seed points; and
for each of the seed points,
determining a plurality of neighboring points of the seed point, and
determining the seed point and the plurality of neighboring points as one point cloud block.

4. The method according to claim 3, wherein a point density of a point cloud block is determined based on a distance between the seed point in the point cloud block and each neighboring point of the seed point.

5. The method according to claim 1, wherein adjusting the first point cloud completion network based on the points-distribution feature to generate the second point cloud completion network comprises:
establishing a first loss function based on the points-distribution feature of the first point cloud data, wherein the first loss function represents a distribution evenness of the points in the first point cloud data;
establishing a second loss function based on the first point cloud data and complete point cloud data from a sample point cloud data set, wherein the second loss function represents a difference between the first point cloud data and the complete point cloud data; and
training the first point cloud completion network based on the first loss function and the second loss function to obtain the second point cloud completion network.

6. The method according to claim 1, wherein adjusting the first point cloud completion network based on the points-distribution feature to generate the second point cloud completion network comprises:
establishing a third loss function based on the points-distribution feature of the first point cloud data;
establishing a fourth loss function based on a difference between corresponding point cloud data and real point cloud data collected in a physical space, wherein the corresponding point cloud data is acquired from the first point cloud data by performing a preset degradation process; and
optimizing the first point cloud completion network based on the third loss function and the fourth loss function to obtain the second point cloud completion network.

7. The method according to claim 6, wherein performing the preset degradation process comprises:
determining, corresponding to any target point in the real point cloud data, at least one neighboring point in the first point cloud data which is nearest to the target point; and
determining a union of respective neighboring points in the first point cloud data corresponding to various target points in the real point cloud data as the corresponding point cloud data.

8. The method according to claim 1, further comprising:
acquiring raw point cloud data collected by a point cloud collecting device in a three dimensional (3D) space;
performing a point cloud segmentation on the raw point cloud data to obtain second point cloud data of at least one object; and
completing the second point cloud data by adopting the second point cloud completion network.

9. The method according to claim 8, further comprising:
detecting an association between at least two objects based on the completed second point cloud data of the at least two objects.

10. A method of processing point cloud data, comprising:
acquiring a first to-be-processed point cloud of a game participant and a second to-be-processed point cloud of a game object with a game area;
inputting the first to-be-processed point cloud and the second to-be-processed point cloud into a second point cloud completion network to acquire a first processed point cloud and a second processed point cloud, wherein
the second point cloud completion network has been pre-trained, and
the first processed point cloud and the second processed point cloud are outputted by the second point cloud completion network and correspond to the first to-be-processed point cloud and the second to-be-processed point cloud respectively; and
associating the game participant and the game object based on the first processed point cloud and the second processed point cloud;
wherein the second point cloud completion network is obtained by adjusting a first point cloud completion network based on a points-distribution feature of first point cloud data, and the first point cloud data is generated by the first point cloud completion network based on one or more latent space vectors.

11. The method according to claim 10, wherein the game object comprises a game coin deposited in the game area; and the method further comprises:
determining, based on an association result between the first processed point cloud and the second processed point cloud, the game coin which is deposited by the game participant in the game area.

12. The method according to claim 10, further comprising:
determining, based on an association result between the first processed point cloud and the second processed point cloud, an action performed on the game object by the game participant.

13. The method according to claim 10, wherein acquiring the first to-be-processed point cloud of the game participant and the second to-be-processed point cloud of the game object within the game area comprises:
acquiring raw point cloud data, which is collected by a point cloud collecting device arranged around the game area; and
performing a point cloud segmentation on the raw point cloud data to obtain the first to-be-processed point cloud of the game participant and the second to-be-processed point cloud of the game object.

14. The method according to claim 10, wherein
the second point cloud completion network is configured to complete the respective first to-be-processed point clouds of game participants of various categories and/or the respective second to-be-processed point clouds of game objects of various categories; or
the second point cloud completion network comprises a first point cloud completion subnetwork and a second point cloud completion subnetwork, wherein the first point cloud completion subnetwork is configured to complete the first to-be-processed point cloud of the game participant of a first category, and the second point cloud completion subnetwork is configured to complete the second to-be-processed point cloud of the game object of a second category.

15. An apparatus for generating point cloud completion network, comprising:
a processor; and
a memory for storing executable instructions by the processor;
wherein the processor is configured to:
acquire one or more latent space vectors through sampling in latent space;
acquire first point cloud data generated based on the latent space vectors by inputting the one or more latent space vectors into a first point cloud completion network;
determine a points-distribution feature of the first point cloud data; and
adjust the first point cloud completion network based on the points-distribution feature to generate a second point cloud completion network.

16. An apparatus for processing point cloud data for implementing the method according to claim 10, comprising:
a processor; and
a memory for storing executable instructions by the processor;
wherein the processor is configured to:
acquire a first to-be-processed point cloud of a game participant and a second to-be-processed point cloud of a game object within a game area;
input the first to-be-processed point cloud and the second to-be-processed point cloud into a second point cloud completion network to acquire a first processed point cloud and a second processed point cloud, wherein
the second point cloud completion network has been pre-trained, and
the first processed point cloud and the second processed point cloud are outputted by the second point cloud completion network and correspond to the first to-be-processed point cloud and the second to-be-processed point cloud respectively; and
associate the game participant and the game object based on the first processed point cloud and the second processed point cloud;
wherein the second point cloud completion network is obtained by adjusting a first point cloud completion network based on a points-distribution feature of first point cloud data, and the first point cloud data is generated by the first point cloud completion network based on one or more latent space vectors.
